(19) United States
(12) Patent Application Publication
(10) Pub. No.: US 2006/0246262 A1
(43) Pub. Date: Nov. 2, 2006

(54) Blister board with enhanced heat seal characteristics

(76) Inventor: Svante Roding, Highland Mills, NY (US)

Correspondence Address: INTERNATIONAL PAPER COMPANY, 6285 TRI-RIDGE BOULEVARD, LOVELAND, OH, 45140, US

(21) Appl. No.: 11/119,267

(22) Filed: Apr. 29, 2005

(51) Int. Cl. B41M 5/00; B32B 7/12; B32B 27/40; B32B 29/00; B32B 27/10; B05D 5/00; B05D 7/00

(52) U.S. Cl. 428/195.1; 428/354; 428/537.5; 428/342; 428/500; 428/330; 428/423.1; 427/402; 427/256

(57) ABSTRACT

A blister board useful in the formation of blister packs. The blister board comprises a paperboard substrate, a basecoat comprising an effective amount of a composition containing a clay, calcium carbonate, a primary binder and a protein binder, applied to at least one surface of the substrate, and a topcoat containing an effective amount of a clay, calcium carbonate, a primary binder and a protein binder applied to the basecoat. The coated paperboard is printed with indicia, followed by application of an adhesive onto the printed coated paperboard. A method is disclosed.

### CROSS-REFERENCE TO RELATED APPLICATIONS

Not Applicable

### STATEMENT REGARDING FEDERALLY SPONSORED RESEARCH OR DEVELOPMENT

Not Applicable

### FIELD OF INVENTION

This invention relates to blister board useful in the formation of packaging of the blister pack variety.

### BACKGROUND OF THE INVENTIONS

Blister packs are well known and widely used for packaging of various products such as batteries, screws, tools and products for the pharmaceutical industry, etc. The blisters are usually made of transparent plastic material, thereby allowing the customer to see the products inside the package. There are several types of blister concepts, some with plastic materials on both sides, but frequently there is a board (paperboard) product, usually carrying printed information, which serves as a backing material (substrate) for the plastic blister. This blister is commonly bonded to the backing material employing a heat seal. Paperboard, when employed as the backing material in a blister pack is referred to as blister board. The present invention is directed to this latter type of blister pack and more particularly is directed to a blister board having unique heat sealing characteristics which result in consistent fiber tear of the blister board in preference to destruction of the heat seal by means of which the blister board is bonded to the plastic blister material. This preference provides a blister pack in which the tear resistance of the blister board is less than the tear resistance of the plastic blister material and is less than the tear resistance (destruction) of the heat seal by which the blister board is bonded to the plastic blister material.

It is of great importance that a blister pack provide visible evidence of any unauthorized or unintentional entry into the blister pack. This characteristic of the blister pack is useful to the retailer for detecting pilfering of products (or a portion of the products) from a blister pack. In like manner, the consumer is protected against receiving less than the expected number of items listed on the package. As valuable as is the detection of pilfering, it is also of importance that the blister pack not rupture under such conditions as being dropped on the floor during shelf stocking, customer handling, etc. To a certain extent, these desirable characteristics of the blister pack are in conflict with one another.

For example, if the blister board does not have sufficient visible fiber tear, the packaging entity will reject the board and return it to the manufacturer, at substantial cost to the manufacturer. On the other hand, the manufacturer of the blister board must provide a blister board which will heat seal to the plastic blister material within the shortest possible time, which will develop a heat seal bond which will not rupture during normal handling of the blister pack, and which will tear in preference to destruction of the heat seal bond upon the application of an opening force being applied to the blister pack and its contents. Balancing of the need for selective tear resistance of the blister board during its use performance, with the need for a suitable heat seal which exhibits a tear resistance in excess of the tear resistance of the blister board has created a dilemma for the board manufacturer.

Attempts to provide a suitable blister board have included actions such as reducing the tear strength of the blister board by reducing refining or reducing the amount of starch applied in the size press by lowering the size press starch solids. Other actions include reducing the coat weight of the board which, however, will negatively affect the printing quality characteristics of the board, such as print uniformity, smoothness and gloss.

Printing of the blister board typically involves offset or flexography. Subsequent to printing an adhesive is applied on top of the print before cutting the board to size for final converting into a blister pack. The printed and adhesive coated blister boards are then used for the placement of the products thereon and capture by the placement of a blister over the products, followed by heat sealing of the blister to the blister board.

There is a current trend in the printing industry to print with high tack inks which generally provide a better print quality, but due to the higher tack may cause fiber-based blister board failure or delamination during printing.

The quality of the fiber tear of the blister board is a function of the time, temperature and pressure during the heat seal application of the blister. If the heat seal is not sufficient to withstand normal handling of the blister pack, the blister board product will be rejected, but on the other hand, an excellent heat seal may allow for shorter heat seal times and consequently a higher production speed.

It thus is advantageous for the blister board manufacturer as well as the packaging manufacturer to have available a blister board product having enhanced heat sealing characteristics, which is printable using high tack inks, and which has a tear resistance which is less than the rupture resistance of the heat seal and which will be sufficiently strong as to withstand normal handling of the blister pack as it moves through production processes, storage and shipping activities, and handling at the retail level.

### BRIEF SUMMARY OF THE INVENTION

In accordance with one aspect of the present invention, there is provided a blister board comprising a paperboard formed from papermaking fibers. This paperboard serves as a substrate which is coated on at least one surface thereof with a basecoat and a topcoat.

In one embodiment, the basecoat of the present invention comprises an effective quantity of a composition including pigments such as clays and calcium carbonate, a protein and a primary binder such as polyvinyl acetate. Various known additives such as viscosity modifiers and/or defoamers may be included in the base coat composition.

The topcoat is applied onto the basecoat and comprises an effective quantity of a composition including clays and calcium carbonate, protein, and a primary binder such as polyvinyl acetate. Again, various additives may be employed such as viscosity modifiers, lubricants, and/or defoamers.

After the coated paperboard is printed, an effective quantity of an adhesive is applied to that printed surface of the blister board which is to receive and be bonded to the plastic blister material.

The resultant blister board of the present invention has been found to exhibit a tear resistance which is less than the tear (rupture) resistance of plastic blister material and less than the tear resistance of the heat seal bond between the blister board and the plastic blister material, whereby application to the blister pack of an opening force, the blister board preferentially tears, leaving visible fiber tear evidence of the opening of the blister pack.

Moreover, it has been found that the time for formation of an excellent heat seal, employing blister board of the present invention, is lessened relative to the known blister boards employed in the prior art. Further, the actual amount of fiber tear of the heal seal is selectable through, among other things, selection of the quantity of various of the components of the topcoat, and to a lesser extent, the basecoat, applied to the paperboard substrate, coupled with the overall quantity of each coating applied to the substrate.

Quite unexpectedly, the present invention has been found to enhance the printability of the blister board when employing high tack inks.

### BRIEF DESCRIPTION OF THE SEVERAL VIEWS OF THE DRAWINGS

FIG. 1 is a schematic representation of a blister board embodying various of the features of the present invention;

FIG. 2 is a diagrammatic representation of one embodiment of the method of the present invention;

FIG. 3 is a graphic representation of the time required for heat sealing the present blister board to a plastic blister material versus the percent fiber tear of the blister board for various coatings;

FIG. 4 is a graphic representation of the final force during laboratory printing, which will effect delamination of blister boards of the present invention at different top coat weights and different calcium carbonate/clay ratios;

FIG. 5 is a graphic representation of the percent fiber tear in the machine cross direction of a test blister board versus the time consumed in making a heat seal between the test board and a control board;

FIG. 6 is a graphic representation of the percent fiber tear in the machine direction of a test blister board versus the time consumed in making a heat seal between the test board and a control board;

FIG. 7 is a graphic representation of the rate of tack build during laboratory printing on blister boards of the present invention at different coat weights and combinations of components of a topcoat applied to a paperboard substrate; and

FIG. 8 is a graphic representation of the effect of primary binder amount in the topcoat versus fiber tear in the machine direction of a blister board of the present invention and of varying amounts of total coat weight.

### DETAILED DESCRIPTION OF THE INVENTION

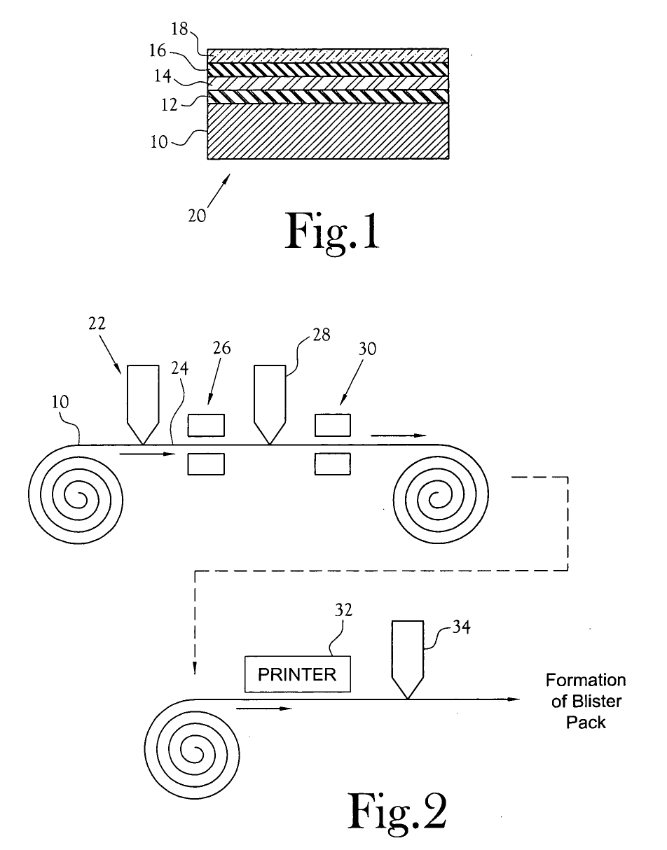

Referring to FIG. 1, in a preferred embodiment of the present invention, a paperboard substrate 10 formed from papermaking fibers is provided with a base coat 12, followed by a top coat 14 overlaid upon the base coat. This coated paperboard is printed 16 and an adhesive layer 18 is overlaid onto the printed surface to complete the blister board 20. This blister board is subsequently bonded to a blister material to form a blister pack.

The paperboard of the present invention may be formed from fiber furnishes including bleached or unbleached kraft, softwood and hardwood fibers or mechanical pulps such as thermomechanical pulp (TMP) and Chemithermomechanical pulp (CTMP), by processes known in the art. Commonly, paperboard caliper range of between about 14 and about 28 points are useful for forming blister board. Other caliper paperboards may be employed, however. Preferably, the paperboard is formed using low starch solids in the size press, preferably below about 5%.

In accordance with one aspect of the present invention, the paperboard 10, as noted, is first coated 22 on at least one surface 24 with a basecoat, FIG. 2. The base coat is dried 26 and a topcoat applied 28 over the basecoat followed by drying 30 of the topcoat. The thus coated substrate is thereafter printed 32 onto the topcoat, followed by application 34 of an adhesive onto the printed surface to complete the blister board 20. This blister board is thereafter cut to size, products are placed thereon, and captured by a blister, commonly of polyvinyl chloride polymeric material.

Each of the basecoat and the topcoat of the present invention comprises an effective amount of a composition comprising selective amounts of clay and calcium carbonate, a binder, and protein in each of the base coat and the topcoat. Whereas other components such as a lubricant, a viscosity modifier and/or a defoamer may be included in the composition of each of the basecoat and/or topcoat, as desired, these components are present in relatively small individual quantities, as is known in the art.

Further, each of the basecoat and the topcoat includes a primary binder, preferably polyvinyl acetate such as that supplied by Air Products as 828M.

The present inventors have found that by providing two coats, even though the coats are made up of like materials, one can obtain a blister board which has unique and unexpected properties that are desirable in blister board, by selectively altering the effective quantities of various of the individual components of each of the two coatings.

TABLE A

| | BLISTERPAK FORMULATIONS | | | | | | | | | | |
|---|---|---|---|---|---|---|---|---|---|---|---|
| | | Roll 2 | Roll 3 | Roll 4 | Roll 5 | Roll 6 | Roll 7 | Roll 8 | Roll 9 | Roll 10 | Roll 11 |
| Ingredients | Control | w/o plastic | Effect of Pigment Ratio | | | Effect of Binder Type | | | | Binder Amount | |
| | Base Coating | | | | | | | | | | |
| Calcium Carbonate- H60 | 43 | 43 | 43 | 43 | 43 | 43 | 43 | 43 | 43 | 43 | 43 |
| No. 2 Clay Slurry | 57 | 57 | 57 | 57 | 57 | 57 | 57 | 57 | 57 | 57 | 57 |
| Portein-Procote 5000 | 2.5 | 2.5 | 2.5 | 2.5 | 2.5 | 2.5 | 2.5 | 2.5 | 2.5 | 2.5 | 2.5 |
| Polyvinyl Acetate-Air Products 828M | 17.5 | 17.5 | 17.5 | 17.5 | 17.5 | 8.5 | 8.5 | 8.5 | 8.5 | 17.5 | 17.5 |
| SA Latex-BASF S728 | | | | | | 9 | | | | | |
| SA Latex-BASF S866 | | | | | | | 9 | | | | |
| SA Latex-BASF 504 | | | | | | | | 9 | | | |
| SBR Latex BASF Styronal BN4606 | | | | | | | | | 9 | | |
| Viscosity Modifier | 0.1 | 0.1 | 0.1 | 0.1 | 0.1 | 0.1 | 0.1 | 0.1 | 0.1 | 0.1 | 0.1 |
| | Top Coating | | | | | | | | | | |
| Calcium Carbonate- H60 | 20 | 20 | 35 | 50 | 80 | 20 | 20 | 20 | 20 | 20 | 20 |
| Glossing Clay-Hydragloss-91 | | | | | | | | | | | |
| No. 1 Coating Clay | 80 | 80 | 65 | 50 | 20 | 80 | 80 | 80 | 80 | 80 | 80 |
| Plastic Pigments, solid | 8 | | | | | | | | | | |
| Protein-Procote 5000 | 1 | 1 | 1 | 1 | 1 | 1 | 1 | 1 | 1 | 2 | 1 |
| Polyvinyl Acetate-Air Products 828M | 16 | 16 | 16 | 16 | 16 | 8 | 8 | 8 | 8 | 14 | 19 |
| SA Latex-BASF S728 | | | | | | 8 | | | | | |
| SA Latex-BASF S866 | | | | | | | 8 | | | | |
| SA Latex-BASF 504 | | | | | | | | 8 | | | |
| SBR Latex BASF Styronal BN4606 | | | | | | | | | 8 | | |
| Viscosity Modifier | 0.14 | 0.14 | 0.14 | 0.14 | 0.14 | 0.14 | 0.14 | 0.14 | 0.14 | 0.14 | 0.14 |
| Lubricant-Calcium Stearate | 0.8 | 0.8 | 0.8 | 0.8 | 0.8 | 0.8 | 0.8 | 0.8 | 0.8 | 0.8 | 0.8 |
| Defoamer, Slimicide, Ammonia | if | if | if | if | if | if | if | if | if | if | if |
| | needed | needed | needed | needed | needed | needed | needed | needed | needed | needed | needed |

TABLE “A” presents data relating to multiple runs of basecoats and topcoats applied to a paperboard substrate in accordance with the present invention. It will be noted from this Table that whereas the basecoat includes 57 parts of coating clay, the topcoat includes between 20 and 80 parts of coating clay. Whereas the topcoat of the coated paperboard is destined to be printed, the larger amounts of coating clay have been found to enhance the printing quality of the final blister board. Plastic pigments may also be employed in the topcoat to enhance the print quality, but have not been found to be required.

2.5 parts of protein binder (Procote 5000 from DuPont) may be included in the basecoat. In the topcoat, the protein may be present in an amount of between about 1 and 2 parts.

From TABLE “A” it will be noted that both the amount of polyvinyl acetate primary binder present in the basecoat ranges between 8.5 parts to 17 parts, and the amount of this same binder in the topcoat ranges from 8.5 to 17 parts.

All conditions of the runs of the tests recorded in TABLE “A” were run at two base and top coat weights, namely: 5+5 lbs/3000 ft² and 7+7 lbs/3000/ft².

In these runs, the basecoat was applied with a stiff blade while the topcoat was applied with a bent blade. Initial drying of the coats was with IR dryers followed by air flotation dryers. Of these tests, runs 4 and 5 were noted to exhibit the most preferred compositions for the basecoat and the topcoat.

Laboratory testing of the heat seal was performed by first applying the adhesive Solucote 1051-3-35 onto the printed topcoat with a draw down rod #6 wire purchased from Gardoco, Pompano Beach, Fla. The actual heat seal blister application was performed using an EZB Table Top Blister Sealer from Zed Industries, of Vandalia, Ohio. The amount of fiber tear was evaluated by cutting the polyvinyl chloride (PVC) blister in four parts and pulling the plastic in the opposite directions, machine direction and cross direction. The amount of fiber tear was rated from 0% to 100% for each direction. The standardized heat seal procedure depends on the caliper of the board, with the heavier weight requiring longer time and/or higher temperature for acceptable performance. The standard procedure for 18 Pt paperboard is 400° F., 2.0 second dwell time and 60 PSI pressure. However, since the control was expected to meet a minimum 80% fiber tear, the tests were run at several different dwell times to facilitate determining differences in performance for the various trial conditions.

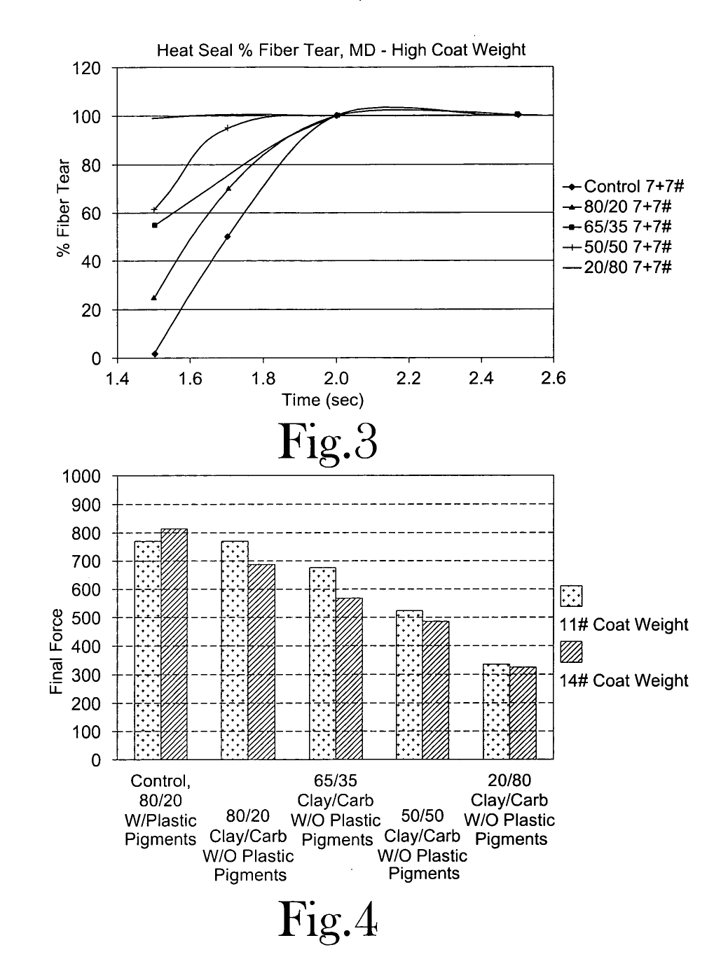

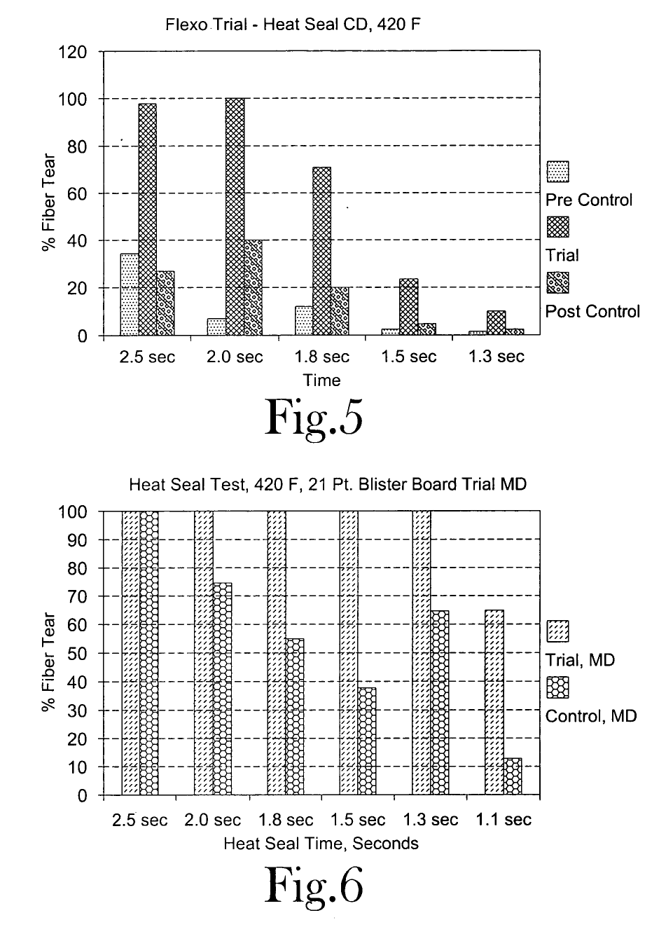

The heat sealing clearly showed improved performance as the coarse calcium carbonate was increased in the topcoat and the clay pigments reduced, as illustrated in FIG. 3. At 2 seconds, all conditions gave 100% fiber tear, but at shorter dwell times the improved heat seal performance at the increased calcium carbonate to clay ratio was apparent.

TABLE B

| | | | Unprinted | Printed | Delta Gloss | Print | |
|---|---|---|---|---|---|---|---|
| Formulation | Brightness | PPS | Gloss | Gloss | Snap | Density | Wax Pick |
| Control | 83.8 | 1.2 | 67.4 | 78 | 10.6 | 1.34 | 7 |
| w/o Plastic pgm | 83.6 | 1.32 | 53.5 | 74.2 | 20.7 | 1.35 | 6 |
| 35/65 | 84.1 | 1.55 | 45 | 68.7 | 23.7 | 1.36 | 7 |
| 50/50 | 84.8 | 1.71 | 37.5 | 62 | 24.5 | 1.35 | 7 |
| 80/20 | 85.8 | 1.96 | 17.9 | 46 | 28.1 | 1.26 | 8 |

Although heat seal performance is the most critical property of blister board, it is essential that as the heat seal is improved other properties do not deteriorate substantially. The properties of the pigment ratio samples at the lower coat weight are illustrated in TABLE “B”. The samples with 50/50 and 80/20 calcium carbonate to clay ratio showed higher brightness, worse PPS smoothness and gloss. However, the printed gloss was only marginally lower, since these samples had significantly higher snap. In addition commercial printing showed the high calcium carbonate samples to actually have slightly better print mottle.

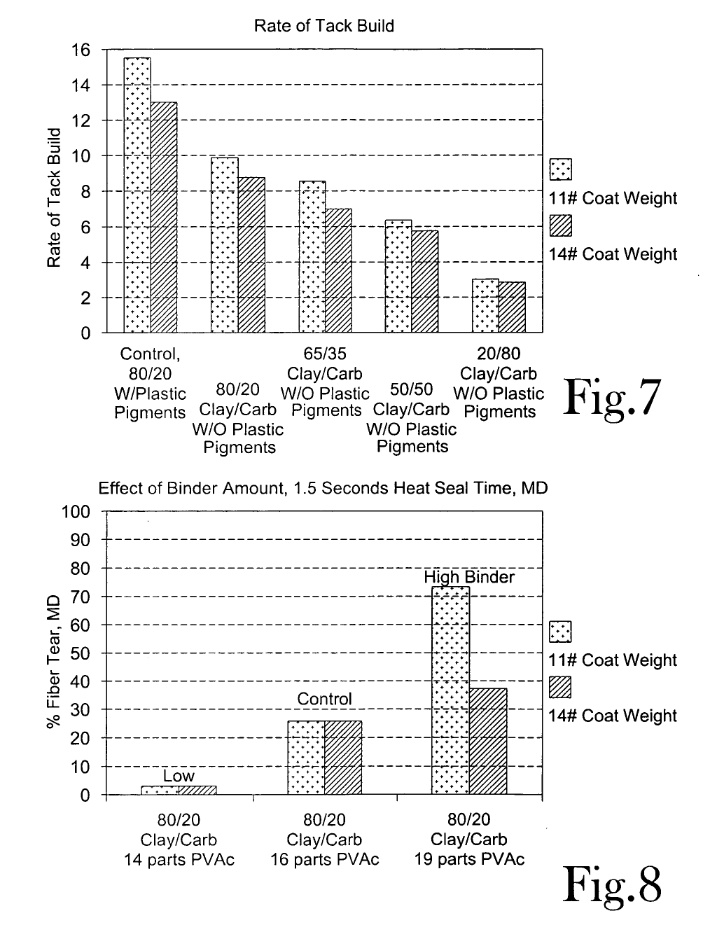

Printers are tending to use higher tack inks to enhance the print quality. However, since blister board in essence is designed for internal fiber tear, this makes this product more susceptible to delamination when printed with high tack inks. Although, the commercial printing showed no indication of delamination problems, there are specific tests to measure the rate of tack build. Tests were performed on a Vandercook Press, with a method that in all principles is identical to Nancy Plowman Associates P & I test (Paper and Ink Stability test). P & I tests can be performed by Nancy Plowman Associates at 30-32 Ray Avenue, Burlington, Mass. 01803. Test results showed that the formulations with increased carbonate had a lower rate of tack build and a lower final force after 10 repetitions, FIGS. 4 and 7. Consequently, the high carbonate formulation will also be less likely than the control to delaminate when printed with high tack inks.

Follow up tests confirmed the negative effects of higher size press solids and indicated improvements in heat seal by the trial coating at 50/50 calcium carbonate to clay ratio, without negative impact on the print quality. Still further testing showed that a coating of 60/40 calcium carbonate to clay ratio further improved heat seal with good print quality in offset and flexography printing.

Thus, in one embodiment, the basecoat clay may be the pigment identified as No. 2 clay (KCS), available from Imerys. In the composition of the basecoat, about 57 parts of this clay are present within the basecoat composition.

In this embodiment, the calcium carbonate may be that identified as course calcium carbonate, Hydrocarb 60 (H60), available from Omya. In this calcium carbonate about 50 to 70% of the particulates are less than 2 microns in size. In a preferred basecoat composition the calcium carbonate to clay ratio is 43/57. The topcoat clay may be a No. 1 coating clay identified as Thiele Kaogloss 90. In the topcoat composition the calcium carbonate to clay ratio is between about 40/60 and about 80/20 and preferably about 60/40. The primary binder in the preferred composition of each coat is polyvinyl acetate, present in an amount of about 16 parts plus about 1-2 parts protein binder. Stronger binders such as styrene acrylic (SA) or styrene butadiene rubber (SBR) are not advantageous since they generally provide a less open coating structure. Further, the use of plastic pigments in the top coat is not indicated to be advantageous. The coat weight should be sufficiently high to achieve the print quality target, but generally a higher coat weight has a negative impact on the heat seal. A suitable total coat weight (basecoat and topcoat) range is from 8 to 15 lb/3000 ft².

Whereas variations in the composition of the base coat have not been fully investigated, it is believed that even further advantages are available through selective adjustment of the composition of the base coat.

The exact mechanism by which the present invention provides the discovered advantages is not known, but it has been postulated that the blister board fiber tear is a weakest link phenomenon. Consequently the adhesion of the blister to the top coat, the strength of the top coat, the adhesion between the top and the basecoat, the strength of the basecoat and the adhesion of the basecoat to the basesheet all need to be stronger than the internal strength of the basesheet in order to produce fiber tear. It has also been speculated that the adhesive penetrates through the coatings into the basesheet to facilitate this failure mechanism. However, microscopy analysis has demonstrated that the adhesive only penetrates marginally into the top coat. Instead of this hypothesis, it is believed that the binder in the basecoat needs to penetrate into the base sheet for sufficient bonding. A more open basesheet is therefore helpful. A more open basesheet can be achieved by less refining and less starch application, which both reduce the internal strength and allow more binder migration into the basesheet. Subsequently, the basecoat needs to be open in structure to allow binder migration from the top coat. Course carbonate in the basecoat helps as well as using PVAc and protein, which are believed to open the coating sturcture. The experiments with alternate binders of higher strength generally worsened the heat seal, which is believed caused by a reduced penetration for these binders. Finally, an open structure top coat allows for more migration of binder to the base coat, which improves the base to top coat adhesion. In addition, the more open top coat structure makes the surface rougher and less glossy, but assists in the penetration of the adhesive into the top coat. A rougher surface with larger average pore size distribution also explains the lower tack rate build and ink tack forces. The use of larger amounts of coarse calcium carbonate in the top coat is believed to create this more open structure.

The present invention which achieves an improved heat seal, provides (1) the board manufacturer a wider operating window in manufacturing board with required heat seal, (2) gives the blister board manufacturer a safety margin from complaints from his customer, and (3) allows the blister board packaging manufacturer to operate with fewer rejects and potentially at a higher operating speed.

What is claimed:

1. A blister board useful in the formation of blister packs comprising
a paperboard substrate,
a basecoat applied directly to at least one surface of said substrate,
a topcoat applied directly to said basecoat,
said basecoat including
an effective quantity of a composition comprising between about 30 parts and about 70 parts of a clay and between about 30 parts and about 70 parts of calcium carbonate, between about 1 and about 3 parts of a protein binder and between about 12 and about 20 parts of a primary binder,
said topcoat including
an effective quantity of a composition comprising between about 15 and about 85 parts of a clay and between about 15 and 85 parts of calcium carbonate, between about 0.5 parts and about 3 parts of a protein binder, and between about 6 parts and about 25 parts of a primary binder,
said basecoat being applied directly on at least one surface of said substrate and said topcoat being applied on said basecoat.

2. The blister board of claim 1 and wherein said basecoat and said topcoat, each, includes a viscosity modifier, a defoamer and/or a lubricant.

3. The blister board of claim 1 wherein said effective quantity of said basecoat composition applied to said paperboard substrate exhibits a coat weight between about 3.5 and about 8.5 lbs/3000 ft².

4. The blister board of claim 1 wherein said effective quantity of said topcoat applied to said basecoat exhibits a coat weight between about 3.5 and about 8.5 lbs/3000 ft².

5. The blister board of claim 1 wherein the combined effective quantities of said basecoat and said topcoat is between about 7 lbs/3000 ft² and about 17 lbs/3000 ft².

6. The blister board of claim 1 and further including printing applied to said topcoat employing a high tack ink to define a printed surface on the blister board.

7. The blister board of claim 6 and further including an adhesive applied to said printed surface of the blister board.

8. The blister board of claim 1 wherein said primary binder comprises polyvinyl acetate.

9. The blister board of claim 8 wherein said primary binder is present in said composition at between about 12 and about 20 parts in each of said basecoat and said topcoat.

10. The blister board of claim 9 wherein said primary binder is present in said composition at about 17 parts in each of said basecoat and said topcoat.

11. The blister board of claim 1 wherein said paperboard is treated in a size press having a starch solids content of less than about 5%.

12. The blister board of claim 1 wherein said calcium carbonate comprises particulates, between about 50% and about 70% of which are less than 2 microns in size.

13. The blister board of claim 1 wherein said adhesive comprises a polyurethane dispersion.

14. The blister board of claim 1 wherein the caliber of said paperboard substrate ranges between about 14 Pt and 28 Pt.

15. A method of preparing a blister board comprising the steps of
forming a paperboard,
coating at least one surface of said paperboard with a basecoat comprising an effective amount of a composition including calcium carbonate, a papermaking clay, a primary binder and a protein binder,
applying onto said basecoat a topcoat comprising an effective amount of a composition including calcium carbonate, a papermaking clay, a primary binder and a protein binder,
printing indicia onto said topcoat, and
applying a layer of adhesive onto said topcoat.

16. The method of claim 15 wherein said effective amount of said basecoat ranges between about 3.5 lbs/3000 ft² and about 8.5 lbs/3000 ft².

17. The method of claim 15 wherein said effective amount of said topcoat ranges between about 3.5 lbs/3000 ft² and about 8.5 lbs/3000 ft²

18. The method of claim 15 wherein the caliber of said paperboard ranges between about 14 Pt and about 28 Pt.

19. The blister board of claim 1 and including a polymeric blister pack material, said blister board and said blister pack material being selectively heat sealed to one another to define a blister pack.

20. The blister board of claim 19 wherein said blister board preferentially tears relative to rupture of said heat seal upon opening of said blister pack.
